(19) United States
(12) Patent Application Publication
(10) Pub. No.: US 2022/0325092 A1
(43) Pub. Date: Oct. 13, 2022

(54) A COMPOSITE

(71) Applicant: AGENCY FOR SCIENCE, TECHNOLOGY AND RESEARCH, Singapore (SG)

(72) Inventors: Alex Yong Sheng ENG, Singapore (SG); Zhi Wei SEH, Singapore (SG)

(21) Appl. No.: 17/638,788

(22) PCT Filed: Aug. 26, 2020
(86) PCT No.: PCT/SG2020/050497

§ 371 Date: Feb. 25, 2022

(30) Foreign Application Priority Data
Aug. 26, 2019 (SG) 10201907873S

(51) Int. Cl. C08L 33/20; C08F 8/34; H01M 10/0568

(52) U.S. Cl. CPC C08L 33/20; C08F 8/34; H01M 10/0568; H01M 2300/0037

(57) ABSTRACT

There is provided a composite comprising a) a short chain sulfur; and b) a carbon-supported conductive polymer such as polyacrylonitrile, wherein sulfur atoms of said short chain sulfur are covalently linked to the conductive polymer of said carbon-supported conductive polymer via a C—S bond. A method of preparing said composite comprising polymerizing a plurality of monomers in the presence of a carbon scaffold, mixing elemental sulfur and heating the mixture to obtain said composite is also disclosed. An electrochemical cell comprising said composite as cathode, a sodium anode and a liquid electrolyte such as sodium trifluoromethanesulfonate dissolved in a mixture of solvents is disclosed.

### CROSS-REFERENCE TO RELATED APPLICATION

This application makes reference to and claims the benefit of priority of an application for “Sulfur-Polyacrylonitrile Composites from Acrylonitrile Polymerization on Carbon Scaffolds for Room-Temperature Sodium-Sulfur Batteries” filed on 26 Aug. 2019 with the Intellectual Property Office of Singapore, and duly assigned application Ser. No. 10/201,907873S. The content of said application is incorporated herein by reference for all purposes, including an incorporation of any element or part of the description, claims or drawings not contained herein.

### TECHNICAL FIELD

The present invention generally relates to a composite. The present invention also relates to a method of preparing the composite, use of the composite as a cathode material and an electrochemical cell comprising the cathode material.

### BACKGROUND ART

Recent advancements in sodium-sulfur battery technology make it a prospective replacement candidate for lithium-ion batteries, consisting primarily of Earth-abundant and cheaper raw materials such as sodium, sulfur, and carbon. Nonetheless, practical limitations must first be overcome, which includes poor cycling stability of the sulfur cathode when used in combination with a sodium anode. This phenomenon is severe in the sodium system, and occurs as a result of structural degradation caused by recurrent volume expansion and contraction cycles.

In addition, conventional methods to form carbon-sulfur cathodes may not result in chemically stable cathodes or tend to be restricted in their morphologies and compositions. Where electrospinning is used to form the carbon support, this requires complex machinery and the products obtained are not suitable for conventional, large scale battery fabrication.

There is a need to provide a composite that overcomes, or at least ameliorates, one or more of the disadvantages described above.

There is a need to provide a composite as a cathode material that overcomes, or at least ameliorates, one or more of the disadvantages described above.

### SUMMARY

In one aspect, there is provided a composite comprising: a) short chain sulfur; and b) a carbon-supported conductive polymer, wherein sulfur atoms of said short chain sulfur are covalently linked to the conductive polymer of said carbon-supported conductive polymer via a C—S bond. Advantageously, the choice of the carbon support allows customization of the morphology of the conductive polymer to adopt the same morphology as the underlying carbon support used.

In another aspect, there is provided a method of preparing a composite comprising: a) short-chain sulfur; and b) a carbon-supported conductive polymer, wherein sulfur atoms of the short-chain sulfur are covalently linked to the conductive polymer of the carbon-supported conductive polymer via a C—S bond, comprising the steps of: (a) polymerizing, in the presence of a carbon scaffold, a plurality of monomers making up the conductive polymer or a plurality of monomers making up a precursor of the conductive polymer; (b) mixing elemental sulfur with the carbon-supported conductive polymer or the carbon-supported conductive polymer precursor obtained in step a); and (c) heating the mixture of the elemental sulfur with the carbon-supported conductive polymer precursor obtained in step b).

Advantageously, the use of monomers as the starting material (as compared to the use of the conductive polymer or conductive polymer precursor itself as the starting material), which are then polymerized in situ with the carbon scaffold, allows for the morphology of the conductive polymer to be tuned according to the morphology of the underlying carbon scaffold used. This is in contrast to using the conductive polymer or conductive polymer precursor as the starting material because the conductive polymer or conductive polymer precursor already has a fixed molecular weight and tends to be particulate, which is not able to distribute well within the various pore structures of the various carbon scaffolds. In contrast, the monomers can be used to polymerize around or within any chosen scaffold.

Further advantageously, the plurality of monomers, once polymerized, are fully integrated or distributed throughout the carbon scaffold structure and thus the carbon-supported conductive polymer can be considered as a single entity.

In another aspect, there is provided a cathode material comprising a composite as defined herein.

In another aspect, there is provided use of the cathode material as defined herein in a sodium-sulfur electrochemical cell.

In another aspect, there is provided an electrochemical cell comprising the cathode material as defined herein, a pure sodium anode and a liquid electrolyte.

Advantageously, when used in the electrochemical cell as defined herein, the porous nature of the composite is able to mitigate the issues related to volume expansion and/or contraction in sodium-sulfur battery cathodes.

### Definitions

The following words and terms used herein shall have the meaning indicated:

The term ‘composite’ is to be interpreted broadly to refer to a material that has a number of components or species that make up the composite. In the context of this specification, as used herein, the composite is considered as a two-component composite or binary composite, rather than a ternary composite, whereby the components in the composite are as defined further below. The components of the composite are not merely an admixture, but are present in the composite with some form of interaction or bonding with each other.

As used herein, the term ‘conductive polymer’ in the context of this specification is taken to mean a polymer that is able to conduct electricity. This refers to polymers that are naturally conductive without any treatment and normally or native non-conductive polymers that are usually not able to conduct electricity naturally but which can be treated under certain conditions (such as adding dopants, changing the pH or heating the polymer to change the structure/configuration of the polymer) to become conductive. When the normally non-conductive polymer is heated, the polymer carbonizes to become a carbonized polymer that is then conductive. Therefore, as used herein, the term ‘conductive polymer’ is taken to mean a polymer that is naturally conductive as well as a treated non-conductive polymer to become conductive (such as a carbonized polymer). A non-conductive polymer before treatment is then termed as a “conductive polymer precursor” or “precursor of conductive polymer”. A ‘polymer’ then refers to a carbon-containing substance composed of macromolecules, with each macromolecule comprising multiple repeating units derived from molecules of lower relative molecular mass.

The term ‘carbonizing’ is to be interpreted broadly to refer to a process of heating a carbon-containing substance (which in the context of this specification, is the conductive polymer precursor) at a sufficiently high temperature in the absence of air (which can be undertaken in an inert atmosphere such as nitrogen gas or argon gas, or in a vacuum) to convert the carbon-containing substance to primarily carbon at the end of the process. When this occurs, the carbon-containing substance is said to have ‘carbonized’. As mentioned above, a carbonized polymer (which is naturally non-conductive before carbonizing) then acquires a conductive ability, becoming a conductive polymer.

The term ‘porous’ when applied to a particulate material is to be interpreted broadly to refer to the structure of the material as having a plurality of pores which can be regarded as openings or depressions (such as on the surface of the material) or cavities within the material that can extend from the surface of the material and inwards into the depths of the material, which can be straight or bending in various orientations in a random manner, or otherwise subsumed within the depths of the material. The pores may result in forming a network of pores within the material. The porous material can be determined by the size of the pores, surface area or pore volume. In view that the pores can be of various shapes, structures or configuration, the pore size can be determined as an average pore size. The term ‘porous’ when applied to a fibrous material containing a plurality of fibers therein is to be interpreted broadly to refer to voids formed between neighbouring fibers. Therefore, although such fibers are by themselves non-porous, this does not mean that the material as a whole is non-porous, as the porosity of the fibrous material is then determined by the voids in-between neighbouring fibers on a macroscopic level. These voids can be large micrometer-sized voids.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a composite will now be disclosed.

There is provided a composite comprising: a) short chain sulfur; and b) carbon-supported conductive polymer, wherein sulfur atoms of the short chain sulfur are covalently linked to conductive polymer of the carbon-supported conductive polymer via a C—S bond.

The composite is a two-component composite or binary composite i.e. composite having two components a) and b) as shown above since carbon support and the conductive polymer of component b) are fully integrated and can therefore be considered as a single entity. Hence, it is understood that the composite defined herein is not a three-components composite (termed as ternary composite) whereby the composite has three components a) short chain sulfur, b) conductive polymer and c) carbon that can be physically distinguished from each other. The composite may be regarded as a carbon-supported sulfur-conductive polymer composite.

The conductive polymer in the composite as defined herein may be naturally conductive or may be a carbonized polymer. Such carbonized polymer may be formed when a precursor of the conductive polymer is subjected to a heating process. The higher the degree of carbonization in the conductive polymer may be indicated by the greater extent of sp²-hybridized carbons in the carbonized polymer.

The conductive polymer of the carbon-supported conductive polymer in the composite may comprise a plurality of monomers such that the carbon-supported conductive polymer can be regarded as comprising a polymerized form of the plurality of monomers on or within a carbon support. The plurality of monomers are those that make up the conductive polymer or those that make up the conductive polymer precursor.

The conductive polymer is selected from the group consisting of carbonized polyacrylonitrile (PAN), polyaniline, polypyrrole, polyacetylene, polyphenylene, polyphenylene sulfide, polythiophene, poly(fluorene)s, polypyrenes, polyazulenes, polynaphthalenes, polycarbazoles, polyindoles, polyazepines, poly(3,4-ethylenedioxythiophene) (PEDOT), poly(p-phenylene sulfide) (PPS), poly(p-phenylene vinylene) (PPV), mixtures and co-polymers thereof. The native polyacrylonitrile (being the conductive polymer precursor) can be treated to allow it to function as a conductive polymer, which can be done by carbonizing the polyacrylonitrile. In this regard, the carbonized polyacrylonitrile is used as the conductive polymer. Where a conductive polymer is naturally conductive, it is not necessary to treat it to make it conductive.

The corresponding monomers of the conductive polymer precursor or of the conductive polymer is then selected from the group consisting of acrylonitrile, aniline, pyrrole, acetylene, phenylene, phenylene sulfide, thiophene, (fluorene)s, pyrenes, azulenes, naphthalenes, carbazoles, indoles, azepines, 3,4-ethylenedioxythiophene, p-phenylene sulfide, p-phenylene vinylene, and mixtures thereof.

The carbon support of the composite may be termed as a carbon scaffold, wherein when such carbon scaffold is present in the composite, the conductive polymer is uniformly distributed within the carbon scaffold structure. For clarity, the polymerized form of the plurality of monomers of the conductive polymer may be fully integrated throughout the carbon scaffold structure. Hence, the carbon-supported conductive polymer here, as stated previously, may be considered as one entity or one component. Further, the resulting polymerized form of the plurality of monomers of the conductive polymer may essentially adopt the same morphology of the carbon support.

The carbon support in the carbon-supported conductive polymer may be a particulate porous carbon or a fibrous carbon. The fibrous carbon may be a plurality of carbon nanofibers or a free-standing carbon cloth comprising interwoven carbon fibers. Accordingly, when the particulate porous carbon is used as the carbon scaffold, the resulting conductive polymer may be in the form of particulate porous conductive polymer. Similarly, when the fibrous carbon is used as the carbon scaffold, the resulting conductive polymer may be in the fibrous form. Therefore, the choice of the type of carbon support can be regarded as affecting or controlling the morphology of the resultant conductive polymer, which is a result of polymerizing the monomers when they are in contact (such as in a mixture or dispersion) with the carbon support.

Where the carbon-supported conductive polymer is porous, the porous carbon-support conductive polymer may be of high porosity such that it provides high surface area and pore volume.

The surface area of the porous carbon-support conductive polymer may be in the range of about 100 m²/g to about 2000 m²/g, about 100 m²/g to about 500 m²/g, about 100 m²/g to about 1000 m²/g, about 100 m²/g to about 1500 m²/g, about 500 m²/g to about 2000 m²/g, about 1000 m²/g to about 2000 m²/g, or about 1500 m²/g to about 2000 m²/g. The surface area may be about 1500 m²/g. The surface area of the pores can be obtained from standard nitrogen adsorption/desorption analysis.

The total pore volume of the porous carbon-support conductive polymer may be at least about 1 cm²/g, at least about 2 cm²/g, at least about 3 cm²/g, at least about 4 cm²/g, at least about 5 cm²/g or greater. The total pore volume may be about 3 cm²/g. The pore volume can be obtained from standard nitrogen adsorption/desorption analysis.

The pore size of the pores may be in the range of about 2 nm to about 500 nm, about 2 nm to about 5 nm, about 2 nm to about 10 nm, about 2 nm to about 15 nm, about 2 nm to about 20 nm, about 2 nm to about 25 nm, about 2 nm to about 50 nm, about 2 nm to about 100 nm, about 2 nm to about 200 nm, about 2 nm to about 300 nm, about 2 nm to about 400 nm, about 5 nm to about 500 nm, about 10 nm to about 500 nm, about 15 nm to about 500 nm, about 20 nm to about 500 nm, about 25 nm to about 500 nm, about 50 nm to about 500 nm, about 100 nm to about 500 nm, about 200 nm to about 500 nm, about 300 nm to about 500 nm, or about 400 nm to about 500 nm. Hence, depending on the type of the carbon support used, said porous carbon-supported conductive polymer may be mesoporous, macroporous or combinations thereof. When the porous carbon-supported conductive polymer is mesoporous, the pore size of such carbon-supported conductive polymer may be in the range of about 2 nm to about 50 nm. When the porous carbon-supported conductive polymer is macroporous, the pore size of such carbon-supported conductive polymer may be greater than 50 nm to about 500 nm. The pore size stated above may refer to an average pore size or average pore distribution size.

The porous carbon scaffold may be, but is not limited to, activated carbon or carbon black. The carbon black may be Ketjenblack (abbreviated thereafter as KB), acetylene black or carbon nanoballs. In a preferred embodiment, the porous carbon scaffold is not carbon nanotube (CNT). It is therefore to be appreciated that other carbon-based materials having a porous internal surface (hereafter termed as a porous carbon-based material) may also be used as the porous carbon scaffold.

Owing to the high porosity as described above, when the composite as defined above is used as an electrode materials in sodium-sulfur batteries, advantageously, said porous composite is able to mitigate the issues related to volume expansion and/or contraction in sodium-sulfur battery cathodes.

As described above, when a fibrous carbon is used as the carbon scaffold, the resulting conductive polymer may be in the fibrous form. The fibrous carbon scaffold may be non-porous and therefore may be termed as non-porous carbon fiber scaffold. Such non-porous carbon fiber scaffold may have a uniform film formed covering individual fiber surfaces. The non-porous carbon fiber scaffold may have a fiber diameter in the range of about 3 μm to about 20 μm, 3 μm to about 5 μm, 3 μm to about 10 μm, 3 μm to about 15 μm, 5 μm to about 20 μm, 10 μm to about 20 μm, or 15 μm to about 20 μm. The fiber diameter may be an average fiber diameter.

Where the fibrous carbon is a free-standing carbon cloth comprising interwoven carbon fibers, the cloth thickness may be in the range of about 200 μm to about 500 μm, about 200 μm to about 300 μm, about 200 μm to about 400 μm, about 300 μm to about 500 μm, or about 400 μm to about 500 μm.

Due to the arrangement of the carbon fibers, voids may be formed between neighboring carbon fibers or contacting carbon fibers. The size of the void (which is also regarded as the separation distance between fibers) may be in the range of about 5 μm to about 50 μm, about 5 μm to about 10 μm, about 5 μm to about 20 μm, about 5 μm to about 30 μm, about 5 μm to about 40 μm, about 10 μm to about 50 μm, about 20 μm to about 50 μm, about 30 μm to about 50 μm, or about 40 pin to about 50 μm.

The short-chain sulfur of the composite defined above may be S₂, S₃, S₄ or mixtures thereof. Other forms of sulfur such as S₅, S₆, S₇ or S₈ is essentially absent in the composite. It is to be understood that all of the sulfur atoms in the composite are covalently bonded or linked to the carbonized conductive polymer of the carbon-supported conductive polymer via C—S bonds. The short chain sulfur as defined herein, when bonded to the conductive polymer, may thus refer to a poly sulfide chain. For example, when the short chain sulfur is S₄, it is understood that the length of the polysulfide chain is four (4).

The short-chain sulfur of the composite may be present in a concentration in the range of about 20 wt % to about 50 wt %, about 20 wt % to about 25 wt %, about 20 wt % to about 30 wt %, about 20 wt % to about 35 wt %, about 20 wt % to about 40 wt %, about 20 wt % to about 45 wt %, about 25 wt % to about 50 wt %, about 30 wt % to about 50 wt %, about 35% to about 50 wt %, about 40 wt % to about 50 wt %, or about 45 wt % to about 50 wt %, based on the total weight of the composite.

In the above composite, the sulfur atoms may be directly connected to one or more carbon atoms of the carbonized conductive polymer of the carbon-supported conductive polymer via C—S bond and/or indirectly via one or more S—S bonds.

Additionally, there is provided a composite comprising: a) short-chain sulfur that is S₂, S₃ or S₄; and b) carbon-supported conductive polymer, wherein sulfur atoms of the short chain sulfur are covalently linked to the conductive polymer of the carbon-supported conductive polymer via a C—S bond, where bulk sulfur or S₈ is essentially absent, wherein said conductive polymer is carbonized and wherein said carbon-supported conductive polymer in the composite may comprise a polymerized form of the plurality of monomers making up the conductive polymer before carbonization on a carbon support. In one embodiment, the conductive polymer is carbonized polyacrylonitrile (PAN) and therefore the monomers mentioned above are acrylonitrile.

Where the conductive polymer is one that is naturally conductive, the composite comprises a) short-chain sulfur that is S₂, S₃ or S₄; and b) carbon-supported conductive polymer, wherein sulfur atoms of the short chain sulfur are covalently linked to the conductive polymer of the carbon-supported conductive polymer via a C—S bond, where bulk sulfur or S₈ is essentially absent, and wherein said carbon-supported conductive polymer in the composite may comprise a polymerized form of the plurality of monomers making up the conductive polymer on a carbon support.

The concentration of the short chain sulfur of the composite may be adjusted by varying a ratio of the starting materials that is between elemental sulfur (S₈) and the carbon-supported conductive polymer or carbon-supported conductive polymer precursor. Such ratio may be in the range of about 2:1 to about 6:1, such as 2:1, 3:1; 4:1, 5:1 or 6:1. Further, the ratio may refer to the weight ratio between the elemental sulfur and the carbon-supported conductive polymer or carbon-supported conductive polymer precursor. Such weight ratio may in turn refer to the initial weight ratio between the elemental sulfur and the carbon-supported conductive polymer or carbon-supported conductive polymer precursor. The term “initial” in the initial weight ratio refers to the weight ratio prior to mixing the short chain sulfur precursor and carbon-supported conductive polymer or carbon-supported conductive polymer precursor. Hence, it is to be appreciated that the short chain sulfur precursor may be elemental sulfur (S₈). For clarity, in an exemplary embodiment, for a ratio of 5:1, 500 mg of elemental sulfur is mixed with 100 mg of carbon-supported conductive polymer precursor (such as carbon-supported PAN).

Since the type of morphology of the composite is particulate, such composite may be advantageously compatible with standard industry method particularly in a slurry coating process. Yet advantageously, when used as the cathode material in a sodium-sulfur battery, said battery exhibits at least one of the following properties: high cycling stability, high specific capacity and Coulombic efficiencies close to 100% (such as 99.9%). The composite may advantageously be able to prevent or mitigate structural degradation brought about by repeated volume expansion/contraction cycles.

Where a fibrous carbon scaffold is used, the unique morphology of the fibrous carbon scaffold may allow volume expansion i.e. radial expansion along the fiber and therefore may be suitable for use in sodium sulfur batteries.

It is important to note that only cathode scaffolds having internal voids such as those described above that may adequately allow for volume expansions are suitable for sodium-sulfur batteries.

The composite as defined herein preferably consists of: a) short chain sulfur; and b) carbon-supported conductive polymer, wherein sulfur atoms of the short-chain sulfur are covalently linked to conductive polymer of the carbon-supported conductive polymer via a C—S bond Similar as above, depending on the desired type of conductive polymer, the conductive polymer may be carbonized. In one embodiment, the conductive polymer is carbonized polyacrylonitrile (PAN).

Exemplary, non-limiting embodiments of a method of preparing a composite will now be disclosed.

The method of preparing a composite comprising: a) short-chain sulfur; and b) carbon-supported conductive polymer, wherein sulfur atoms of the short-chain sulfur are covalently linked to conductive polymer of the carbon-supported conductive polymer via a C—S bond, comprises the steps of:
(a) polymerizing, in the presence of a carbon scaffold, a plurality of monomers making up the conductive polymer or a plurality of monomers making up a precursor of the conductive polymer;
(b) mixing elemental sulfur with the carbon-supported conductive polymer or the carbon-supported conductive polymer precursor obtained in step (a); and
(c) heating the mixture of the elemental sulfur with the carbon-supported conductive polymer precursor obtained in step (b).

It is to be noted that depending on the type of conductive polymer used, step (c) may or may not be needed. Where the conductive polymer is naturally conductive, it is not necessary to treat the polymer to render it conductive, in this regard, step (c) is not required. Where the conductive polymer is not naturally conductive and treatment of the polymer is needed to render it conductive, step (c) is required.

The method may further comprise, before step (a), the steps of:
(a1′) adding a polymerization initiator to a mixture of said plurality of monomers and said carbon scaffold in a solvent; or
(a1″) adding said plurality of monomers to a mixture of a polymerization initiator and said carbon scaffold in a solvent; and
(a2) heating said mixture from step (a1′) or step (a1″) to initiate polymerization.

For the particulate carbon scaffold, the plurality of monomers may be added to the carbon scaffold that has been dispersed in a suitable solvent. Following this, an amount of initiator such as a radical initiator such as azo compounds may be added into the mixture and heated to initiate the polymerization reaction.

Suitable solvent for dispersing the particulate carbon scaffold above may be aqueous solvent, organic solvent or mixtures thereof. Non-limiting examples of organic solvent may include acetic acid, acetone, acetonitrile, benzene, 1-butanol, 2-butanol, 2-butanone, t-butyl-alcohol, carbon tetrachloride, chloroform, cyclohexane, 1,2-dichloroethane, dimethyl formamide (DMF), dimethyl sulfoxide (DMSO), ethanol, ethyl acetate, hexane, methanol, methyl t-butyl ether (MTBE), N-methyl-2-pyrrolidinone (NMP), pentane, 1-propanol, 2-propanol, pyridine, tetrahydrofuran (THF), toluene, triethyl amine, o-xylene, m-xylene, p-xylene, and ethylene carbonate. It is to be appreciated that other solvents not shown above may also be used, as long as the solvent or solvent mixture can adequately disperse the carbon scaffold, and further dissolve both the initiator and plurality of monomers.

The aqueous solvent defined above is essentially water-based solvent or water. Preferred solvent for dispersion of carbon black (such as Ketjenblack) is 1:1 mixture of dimethyl sulfoxide (DMSO) and de-ionized water. To facilitate the formation of uniform dispersion, sonication method such as ultrasonication may be employed for a period of about 20 minutes to one hour (20 minutes, 30 minutes, 40 minutes, 50 minutes or 60 minutes).

The radical initiator added may be radical initiators commonly known such as azobisisobutyronitrile (AIBN) or 1,1′-azobis(cyclohexanecarbonitrile) (abbreviated as ACHN) dissolved in a suitable solvent such as acetone with a concentration of about 5 wt % to about 20 wt % (5 wt %, 10 wt %, 12 wt %, 15 wt %, or 20 wt %). The addition of said radical initiator may be added gradually. Following the addition of the radical initiator, the reaction mixture may be slowly heated to initiate a polymerization reaction. During this polymerization reaction, the plurality of monomers may be converted to the polymerized form of the monomers thereof or polymer thereof. The heating process here may be undertaken in the presence of inert gas such as argon, nitrogen or helium for about 30 minutes to three hours (30 minutes, one hour, two hours, or three hours). The heating process may be undertaken at a temperature of about 40° C. to 90° C. such as 40° C., 50° C., 60° C., 70° C., 80° C., or 90° C.

During the polymerization reaction, the reaction mixture may be stirred vigorously to ensure intimate contact of the starting materials mentioned above.

At the end of the heating process, the carbon-supported conductive polymer or carbon-supported conductive polymer precursor may be optionally washed to remove the unreacted starting materials and finally dried under vacuum.

For the fibrous carbon scaffold, a carbon cloth may be first activated in the presence of strong acid solution such as concentrated nitric acid having concentration in the range of about 5 M to 10 M under reflux (5 M, 6 M, 7 M, 8 M, 9 M or 10 M). The “M”, unless specified otherwise, denotes the unit of concentration expressed in mole per liter. The reflux required for the activation may be undertaken at a temperature from about 110° C. to about 120° C. (110° C., 112° C., 114° C., 116° C., 118° C. or 120° C.) for about 10 hours to 25 hours. Once activated, the carbon cloth may then be washed till a neutral pH is reached (pH of about 7). The activated carbon cloth may be optionally further washed using organic solvent such as methanol and dried at a suitable temperature (from about 60° C. to about 90° C.).

Prior to contacting the activated carbon cloth with the plurality of monomers, the activated carbon cloth may be briefly immersed in a solution containing a radical initiator such as AIBN (3 wt % in acetone) and rapidly dried under vacuum. A mixture of solvent required in the polymerization process may be added to a reactor containing the radical initiator and activated carbon cloth to yield a homogeneous mixture. The plurality of monomers may be added and the mixture may be heated at a temperature of about 40° C. to 90° C. such as 40° C., 50° C., 60° C., 70° C., 80° C., or 90° C., under quiescent condition for about one hour to four hours (one hour, two hours, three hours or four hours). The cloth (fibrous carbon-supported conductive polymer) may then be retrieved and washed using a suitable solvent and finally dried under vacuum. Where the fibrous carbon is carbon nanofibers, similar steps as above may be taken as appropriate.

For the particulate carbon scaffold, the mixing step (b) may comprise a grinding process. The grinding process may involve contacting solid forms of elemental sulfur and carbon-supported conductive polymer or carbon-supported conductive polymer precursor, wherein the particle size of both elemental sulfur and carbon-supported conductive polymer or carbon-supported conductive polymer precursor may be reduced when the same is subjected to impact force, shear force, compression force or combinations thereof. As a result, the reduced size of the elemental sulfur and carbon-supported conductive polymer or carbon-supported conductive polymer precursor may be essentially of uniform size and/or shape. The grinding process as defined herein may be in the form of a physical grinding or physical mixing. For clarity, the above grinding process may be applicable for the particulate carbon-supported conductive polymer. In contrast, for the fibrous carbon-supported conductive polymer, mixing step (b) may comprise the step of homogenously distributing the elemental sulfur over each cloth or surrounding each nanofiber.

The elemental sulfur mentioned above may be present in the common native form of S₈. The elemental sulfur may also refer to any bulk form of sulfur existing in a solid form at room temperature of about 20° C. to 30° C. such as 20° C., 25° C., or 30° C. and atmospheric pressure (about one atm). The morphology of the carbon-supported conductive polymer and thus the morphology of the composite may be advantageously customized or adjusted according to the carbon scaffold used. The customization of the morphology cannot be achieved if the conductive polymer or conductive polymer precursor is directly used as a starting material instead of the plurality of the monomers (which are then polymerized in situ). Further, if the conductive polymer or conductive polymer precursor is directly used, as the molecular weight of the conductive polymer or conductive polymer precursor is already fixed, the conductive polymer or conductive polymer precursor usually exists as a particulate and cannot be expected to be well distributed within the pore structures of the carbon scaffolds. As such, a single entity making up component (b) of the composite as defined above cannot be formed.

The grinding process described here advantageously may not require solvents, which are typically used for dissolution and/or extraction. Hence, the process as defined here may be termed as solvent-free synthesis. Further, ball-milling of the elemental sulfur and carbon-supported conductive polymer or carbon-supported conductive polymer precursor and other additional procedures (such as electrospinning) are not necessary. As such, the above method may be considered cost-effective, particularly from the industrial production perspective. Furthermore, the method for preparing the composite as defined herein may advantageously be used for gram-scale production or further scaled-up production.

The mixture obtained in step (b) which is specific to the mixture of the elemental sulfur with the carbon-supported conductive polymer precursor may be then subjected to the heating step (c) at a temperature range from about 400° C. to about 600° C. Suitable temperature for this step may be 400° C., 450° C., 500° C., 550° C. or 600° C. Other suitable temperatures not shown above but between about 400° C. to about 600° C. may also be used.

As can be seen above, the heating temperature used in the process defined herein is relatively high. It is to be appreciated that when a heating temperature lower than shown above is used, a different composite than that defined herein will be produced. For instance, if a temperature of about 155° C. were used, elemental sulfur will melt and infuse throughout the composite i.e. melt-diffusion and thus produces a different composite. Hence, the heating in step (c) above is not a melt-diffusion process.

For the heating step (c), once the desired temperature is attained, the heating duration may be undertaken from about 2 hours to 12 hours such as from 2 hours, 3 hours, 4 hours, 5 hours, 6 hours, 7 hours, 8 hours, 9 hours, 10 hours, 11 hours, or 12 hours, or therebetween in the presence of one or more gases. Non-limiting examples of the gases that may be used include inert gases such as helium, nitrogen and argon. The preferred gas used for the heating in step (c) is argon. The heating process may thus be undertaken in an enclosed or sealed system. Further, it is to be appreciated that the one or more gases used in the step (c) are not oxygen and hydrogen.

During the heating process in step (c) as described above, the conductive polymer precursor undergoes a carbonization process. During this process, depending on the type of conductive polymer used, cyclization of the conductive polymer precursor occurs. It is also during this heating process that the C—S bonds between short-chain sulfur and the conductive polymer of the carbon-supported conductive polymer is formed. It is during this process that the extent of sp²-hybridized carbons may be increased.

There is provided a method of preparing a composite comprising: a) short-chain sulfur; and b) carbon-supported conductive polymer, wherein sulfur atoms of the short-chain sulfur are covalently linked to the conductive polymer of the carbon-supported conductive polymer via a C—S bond, comprising the steps of:
a) polymerizing, in the presence of a carbon scaffold, a plurality of monomers making up the conductive polymer or a plurality of monomers making up a precursor of the conductive polymer;
b) grinding elemental sulfur with the carbon-supported conductive polymer or the carbon-supported conductive polymer precursor obtained in step (a); and
c) heating the mixture of the elemental sulfur with the carbon-supported conductive polymer precursor obtained in step (b).

Similarly to above, step (c) is optional depending on the type of conductive polymer used. Where the conductive polymer is carbonized polyacrylonitrile (PAN), the conductive polymer precursor is PAN and the monomers are then acrylonitrile.

There is provided a method of preparing a fibrous composite consisting of: a) short chain sulfur; and b) carbon-supported conductive polymer, wherein sulfur atoms of the short-chain sulfur are covalently linked to conductive polymer via C—S bond, comprising the steps of:
a) polymerizing, in the presence of a carbon scaffold, a plurality of monomers making up the conductive polymer or a plurality of monomers making up a precursor of the conductive polymer;
b) uniformly distributing elemental sulfur on the carbon-supported conductive polymer or the carbon-supported conductive polymer precursor obtained in step (a); and
c) heating the mixture of the elemental sulfur with the carbon-supported conductive polymer precursor obtained in step) b).

Similarly to above, step (c) is optional depending on the type of conductive polymer used. Where the conductive polymer is carbonized polyacrylonitrile (PAN), the conductive polymer precursor is PAN and the monomers are then acrylonitrile.

There is also provided a composite comprising: a) short chain sulfur; and b) carbon-supported conductive polymer, wherein sulfur atoms of the short-chain sulfur are covalently linked to conductive polymer of the carbon-supported conductive polymer via C—S bond, wherein said composite is obtained by the method as defined above. Accordingly, it follows that the composite obtained may have similar characteristics as that described previously.

Exemplary, non-limiting embodiments of a cathode will now be disclosed.

The cathode material comprises a composite as defined previously.

There is also provided use of the cathode material defined above in a sodium-sulfur electrochemical cell. The electrochemical cell may be a battery.

The cathode material may further comprise conductive material such as carbon or carbon-based materials. It is noted that other suitable non-carbon based conductive material may also be used. Additionally, said cathode material may also comprise a binder such as polyvinylidene fluoride (PVDF). When the composite as defined herein, conductive carbon and PVDF are present, they may be present in a weight ratio of 7:2:1.

When the particulate composite, conductive carbon and PVDF are present in a weight ratio of 7:2:1, the mixture may then be ground and dispersed in a suitable solvent such as N-methyl-2-pyrrolidone (NMP) to yield a viscous slurry. The slurried cathode material may then be applied onto a surface to form a solid non-porous cathode layer.

Where the carbon-supported conductive polymer is in fibrous form, the composite comprising or consisting of the fibrous carbon-supported conductive polymer may be advantageously used directly without the addition of conductive material and/or binder. Hence, the cathode comprising the free-standing carbon cloth having interwoven carbon fibers may be termed as a free-standing cathode. Where nanofibers are used, the conductive material and/or binder as above may be added.

The cathode comprising or consisting of the particulate or fibrous carbon-supported conductive polymer as defined above may have areal sulfur loadings between about 0.3 to about 1.0 mg of sulfur per cm² such as 0.3, 0.4, 0.5, 0.6, 0.7, 0.8, 0.9 or 1.0 mg of sulfur per cm². Such cathode may be suitable to be used in sodium sulfur batteries. The surface of the cathode above may be porous due to the presence of the porous carbon scaffolds.

For clarity, the fibrous carbon scaffold may have a low gravimetric surface area since it consists of thick fibers having the fiber diameter as defined above having a non-porous solid internal structure. The porosity of such fibrous carbon scaffold may differ from particulate carbon scaffold from a macroscopic perspective. It is important to note that since the fibrous carbon scaffold comprises interwoven fibers with large micrometer-sized voids, which may then be regarded as pores, present between each longitudinally-ordered fiber. Such unique morphology is important since large voids may allow repeated radial expansion and contraction cycles of the composite along each fiber when such composite is used in sodium sulfur batteries.

Where the conductive polymer is carbonized polyacrylonitrile (PAN), the cathode material is a carbon-supported sulfur-polyacrylonitrile (S-PAN) composite cathode.

Exemplary, non-limiting embodiments of an electrochemical cell will now be disclosed.

The electrochemical cell comprises a cathode material as defined herein, a pure sodium anode and a liquid electrolyte. The liquid electrolyte may comprise sodium trifluoromethanesulfonate (NaCF₃SO₃ or NaOTf), being a sodium electrolyte salt, dissolved in a mixture of solvents.

The mixture of solvents may comprise one or more organic solvents. Non-limiting examples of such organic solvents may include carbonate-based solvents selected from diethyl carbonate, ethylene carbonate, propylene carbonate, fluoroethylene carbonate, vinylene carbonate and mixtures thereof or ether (glyme)-based solvents such as tetraglyme (tetraethylene glycol dimethyl ether), diglyme (diethylene glycol dimethyl ether) or monoglyme. It is to be appreciated solvents or mixture of solvents other than shown above may also be used, as long as the solvent or the mixture of solvent can fully dissolve the sodium electrolyte salt.

The electrochemical cell can be used at room temperature (such as about 20° C., about 25° C. or about 30° C., or values therebetweeen).

When used in an electrochemical cell, the composite above that comprises or consists of porous carbon-supported conductive polymer has a unique morphology that is able to aid in mitigating the problems associated with the volume expansion or contraction encountered in sodium sulfur battery. More importantly, this positive effect is provided without impacting the battery performance. Hence, the sodium sulfur electrochemical cell may exhibit high cycling capacities and/or good stability (high Coulombic efficiencies close to 100%).

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a series of images showing the various composites produced in Example 1 below as well as the corresponding starting carbon material. In particular, FIG. 1a shows an image of pure polyacrylonitrile (PAN) polymer and PAN as polymerized on carbon nanotube (CNT) and porous Ketjenblack (KB) scaffolds respectively; FIG. 1b is an image of PAN polymerized on woven carbon fiber cloth; FIG. 1c is a scanning electron microscopy (SEM) image of pure S-PAN composite obtained from acrylonitrile polymerization and after carbonization with sulfur having a scale bar of 100 nm; FIG. 1d is a SEM image of bare unmodified CNT (starting material) having a scale bar of 1 μm; FIG. 1f is a SEM image of porous KB (starting material) having a scale bar of 100 nm; FIG. 1h is a SEM image of woven carbon fiber cloth (starting material) having a scale bar of 1 μm; FIG. 1e is a SEM image of CNT after acrylonitrile polymerization and S-PAN composite formation having a scale bar of 1 μm; FIG. 1g is a SEM image of porous KB after acrylonitrile polymerization and S-PAN composite formation having a scale bar of 1 μm; FIG. 1i is a SEM image of woven carbon fiber cloth after acrylonitrile polymerization and S-PAN composite formation having a scale bar of 10 μm; FIG. 1j is a SEM image of CNT after acrylonitrile polymerization and S-PAN composite formation having a scale bar of 100 nm; FIG. 1k is a SEM image of porous KB after acrylonitrile polymerization and S-PAN composite formation having a scale bar of 100 nm; and FIG. 1l is a SEM image of woven carbon fiber cloth after acrylonitrile polymerization and S-PAN composite formation having a scale bar of 1 μm.

FIG. 2 is a series of fourier-transform infrared (FTIR) spectra where FIG. 2a shows the FTIR spectra of pure polyacrylonitrile polymer and polyacrylonitrile synthesized on various carbon scaffolds and FIG. 2b shows the FTIR spectra of after their carbonization with sulfur to form the corresponding S-PAN composites.

FIG. 3 is a series of galvanostatic charge/discharge curves where FIG. 3a is for pure S-PAN cathode at 0.2 C; FIG. 3b is for S-PAN-CNT at 0.2 C; FIG. 3c is for S-PAN-KB at 0.2 C; FIG. 3d for S-Pan-Cloth at 0.2 C; and FIG. 3e shows cycling performance and Coulombic efficiencies of sodium-sulfur cells with pure and carbon-supported S-PAN composite cathodes.

### EXAMPLES

Non-limiting examples of the invention and a comparative example will be further described in greater detail by reference to specific Examples, which should not be construed as in any way limiting the scope of the invention.

### Example 1

Here, carbon-supported sulfur-polyacrylonitrile composites were formed, with the first step being the polymerization of acrylonitrile on carbon scaffolds, followed by the second step of carbonization with sulfur to form the composites as shown in Scheme 1 below.

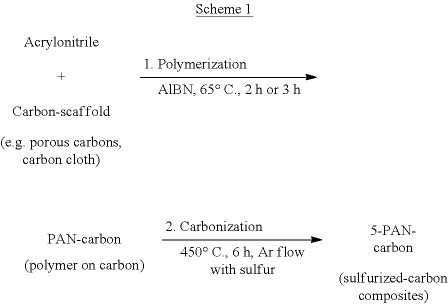

Three representative carbons were used here such as (1) multiwalled carbon nanotubes (CNTs; length: 0.5 to 2 μm, outer diameter: 20 to 30 nm, inner diameter: 1 to 2 nm), obtained from Sigma-Aldrich, Singapore (as a comparative example); (2) porous Ketjenblack (KB; pore width distribution about 2 to 100 nm), obtained from Lion Specialty Chemicals, Japan; and (3) a carbon cloth woven from individual non-porous carbon fibers (fiber diameter about 8 μm, total cloth thickness about 350 μm), obtained from NuVant Systems, Inc. of Indiana of the United States of America.

Acrylonitrile Polymerization on Carbon Scaffolds (First Step)

As-received acrylonitrile monomer (obtained from Sigma-Aldrich, Singapore) was first washed to remove polymerization inhibitors (e.g. monomethyl ether hydroquinone) by solvent extraction, sequentially using 1% sulfuric acid, 1% aqueous sodium hydroxide, and followed three times with deionized water, achieving a neutral pH after the final step. The pure monomer was prepared and promptly used each time to avoid self-polymerization.

1.5 g of CNT or KB was first dispersed by ultrasonication in a 1:1 dimethyl sulfoxide (DMSO)-deionized water mixture (150 mL) for 30 minutes, and further purged with nitrogen in a sealed flask under stirring for 20 minutes. For the synthesis of pure PAN (as control), only the pure DMSO-water mixture was bubbled with nitrogen. Pure acrylonitrile monomer (30 mL) was subsequently injected using a syringe into the above carbon scaffolds or control accordingly. A solution of the radical initiator, azobisisobutyronitrile (AIBN, 12 wt % in acetone, 2.4 mL, obtained from Sigma-Aldrich, Singapore) was gradually introduced and the mixture slowly heated to 65° C., initiating the polymerization reaction. The sealed reaction flask was kept under nitrogen protection and stirred vigorously for 2 hours. After leaving to cool, the gel-like product was washed with methanol three times by centrifugation, and dried in vacuum overnight to give the pure PAN and carbon-supported PAN polymers.

In the case where the carbon scaffold is woven carbon cloth, cloths (ca. 5×5 cm) were first activated by refluxing in 9 M nitric acid at 110 to 120° C. for 20 hours. Each cloth was then washed with copious amounts of deionized water five times until a neutral pH was reached, followed lastly with methanol, and then dried in a 60° C. oven overnight before use. Cloths were briefly soaked in an AIBN solution (3 wt % in acetone) and rapidly dried under vacuum at room temperature, before placement in a sealed flask purged with nitrogen (one cloth per sealed flask). Separately, a DMSO-water mixture was also bubbled with nitrogen for 20 minutes before addition to the flask. Acrylonitrile monomer (10 mL) was introduced and quickly mixed to achieve homogeneity. The mixture was heated to 65° C. under quiescent condition, and kept for 3 hours. Cloths were then retrieved, washed with methanol three times, and stored in vacuum overnight.

Synthesis of Carbon-Supported Sulfur-Polyacrylonitrile Composites by Carbonization with Sulfur (Second Step)

The second step of sulfur carbonization is described here, yielding the four final composites (hereby termed as (i) pure S-PAN, (ii) S-PAN-CNT, (iii) S-PAN-KB, and (iv) S-PAN-Cloth).

Each PAN product (pure PAN, PAN-CNT, PAN-KB) obtained above was mixed with elemental sulfur by physical grinding in an agate mortar and pestle (weight ratio of five times sulfur to each PAN product) for approximately ten minutes to achieve a fine homogeneous powder. While other sulfur-to-PAN ratios were also investigated, the 5:1 weight ratio was determined to be optimal.

For the PAN-Cloth product, an excess of the ground sulfur-PAN powder (obtained by physically grinding elemental sulfur with pure PAN powder) was homogeneously distributed over each cloth.

Each precursor mixture was then transferred to alumina boats and carbonized in an argon-filled tube furnace (Ar-flow rate of 50 sccm, heating rate of 10° C. min⁻¹) maintained at 450° C. for 6 hours before natural cooling to room temperature. Gram scale yields of S-PAN composites may be achieved using this method, with final composites over 1 g obtained.

Particulate-type S-PAN was produced under all conditions except on carbon cloth, where a uniform film was formed instead covering individual fiber surfaces.

Characterization of S-PAN Composites

Surface Area and Pore Information

Surface area and pore information of the carbon additives were first derived from nitrogen adsorption/desorption analysis, representative of low porosity (CNT), high porosity (KB), and macroporous (cloth) carbons respectively.

Table 1 summarizes the surface areas and porosities of three representative carbons. CNTs were employed firstly as a comparative example, with both low surface area and pore volume. In contrast, KB is a common mesoporous carbon produced large-scale for various industrial applications, exhibiting a high surface area and total pore volume more than three times that of the CNT type used herein. The majority of pores exist in the mesoporous region of 2 nm to 50 nm.

Lastly, the carbon fiber cloth has a low gravimetric surface area as it consists of thick fibers (diameter 8 μm) with a non-porous solid internal structure. However, its “porosity” differs from the CNT and KB scaffolds when viewed from a macroscopic perspective. The carbon cloth comprises of interwoven fibers, with large micrometer-sized voids (i.e. pores) existing between each longitudinally-ordered fiber. This unique morphology was found to be important as large voids allow for repeated radial expansion and contraction cycles of the deposited sulfur composite along each fiber, and is corroborated by electron microscopy in the following Section.

TABLE 1
Surface area, pore volumes, and pore width distribution of carbon scaffolds, based on nitrogen adsorption/desorption and Brunauer-Emmett-Teller (BET) surface area analysis.

| | | Modal | Cumulative | Total |
|---|---|---|---|---|
| | Surface | pore width | pore volume | pore |
| Carbon scaffold | area | distribution | in modal range | volume |
| type | (m² · g⁻¹) | (nm) | (cm³ · g⁻¹) | (cm³ · g⁻¹) |
| CNT | 91 | 25 - 120 | 0.6 | 0.9 |
| KB | 1507 | 2-71 | 2.2 | 2.9 |
| Woven carbon cloth | <10 | 55-115 | 0.7 | 1.0 |

Morphologies of Supported Sulfur-Polyacrylonitrile Composites

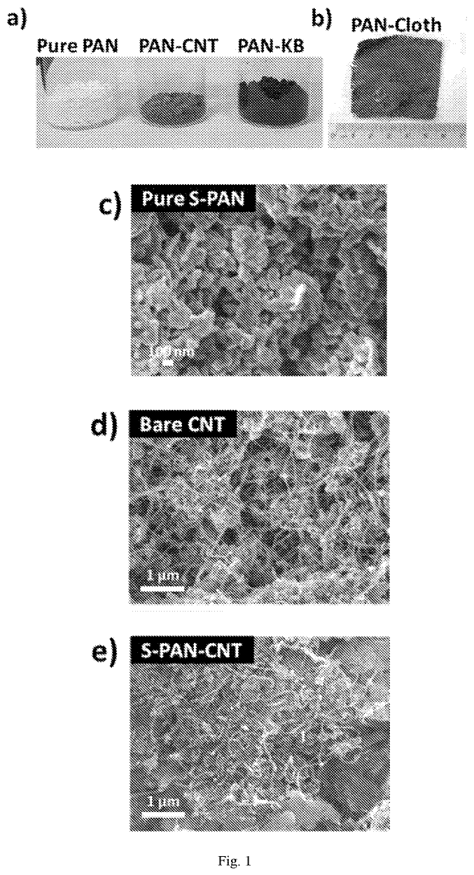

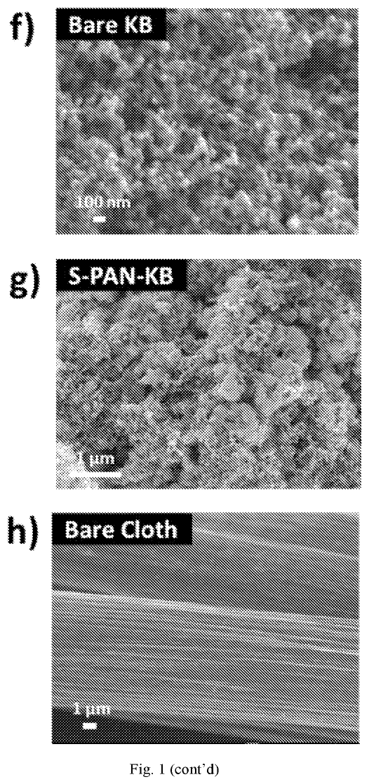

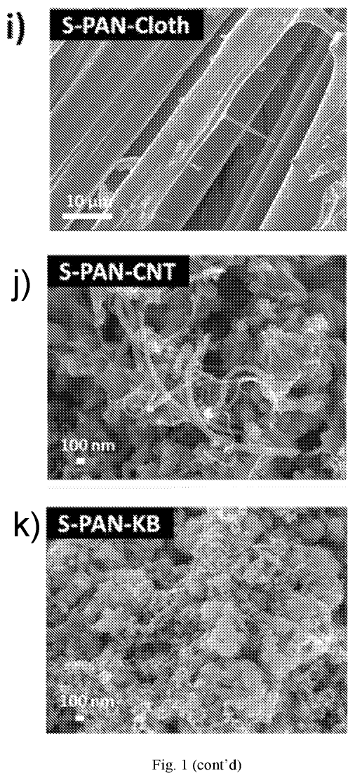

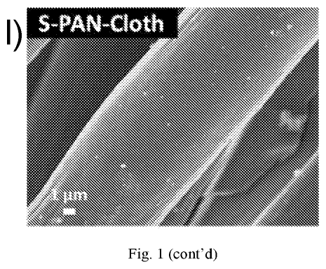

The bare-CNT, bare KB and bare cloth used as starting materials (before the two steps processing above) were assessed using scanning electron microscopy (SEM) and shown in FIG. 1d, FIG. 1f and FIG. 1h, respectively.

Physical appearances of the four PAN polymer materials produced above (first step) are provided in FIG. 1a and FIG. 1b Pure PAN polymer existed as a white particulate solid. In comparison, at the same weight loading of carbon additives (6 wt. % with respect to acrylonitrile precursor), PAN-CNT was obtained as a grey powder while PAN-KB was black (FIG. 1a). Polymerized PAN on nitric acid-activated carbon cloth was produced as a thin translucent film over the black cloth material (FIG. 1b).

After the subsequent carbonization process with sulfur (second step), the pure S-PAN composite showed a particulate morphology, as clusters of globular particles each approximately 100 to 200 nm in diameter (FIG. 1c). The S-PAN-CNT composite (FIG. 1e and FIG. 1j) similarly displayed particulate clusters, but with CNT strands interspersed throughout. Comparatively, unmodified KB carbon consists of porous particles roughly 100 nm in diameter, and was well dispersed within the S-PAN-KB composite (FIG. 1g and FIG. 1k). The carbon cloth is made up of interwoven carbon fibers of approximately 8 μm diameter (FIG. 1h), with an uneven but otherwise non-porous surface. After polymerization and carbonization however, a smooth layer of the composite was observed over the fibers (FIG. 1i and FIG. 1l). Individual fibers maintained their separation of at least several micrometers within the woven matrix, with this space consequently allowing for radial expansion of the S-PAN active layer on each fiber. As such, the synthesized S-PAN-CNT, S-PAN-KB, and S-PAN-Cloth serve as low porosity, high porosity, and macroporous composite variations contrasted against the pure S-PAN composite.

Chemical Structure of Carbon-Supported Polyacrylonitrile and Sulfur-Polyacrylonitrile Composites

Chemical structures of carbon-supported PAN polymers, and their consequent S-PAN composites were elucidated by Fourier-transform infrared (FTIR) spectroscopy (1) to confirm successful radical polymerization of the acrylonitrile monomer to PAN (through formation of C—H bonds along the polymer backbone), and (2) to ascertain chemical stability of the final S-PAN composites by cyclization to give an sp²-conjugated carbon and nitrogen backbone (as C═C and C═N bonds) along with covalent bonding between sulfur and carbon (observed as C—S bonds).

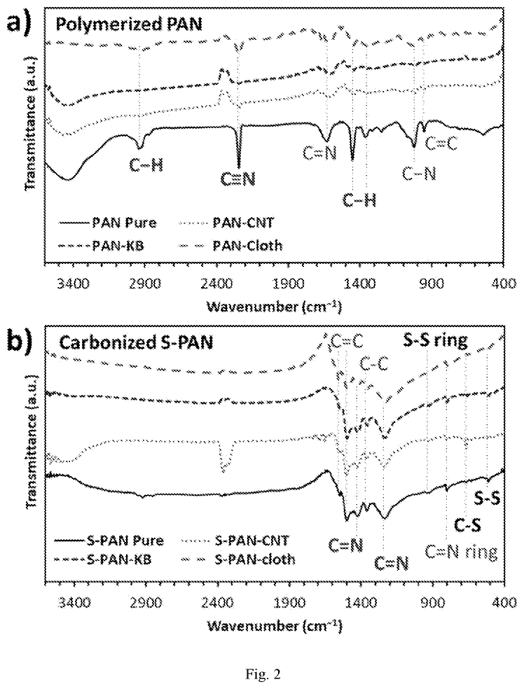

FIG. 2a displays the FTIR spectra of pure PAN polymer and carbon-supported PAN materials produced from the first step above. Most importantly, the absorption at 2935 cm⁻¹ due to aliphatic sp³C—H stretching confirmed successful polymerization, together with peaks at 1450 cm⁻¹ and 1360 cm⁻¹ arising from C—H bending modes. The most prominent band at 2245 cm⁻¹ corresponded to C≡N from the nitrile groups. Weaker absorptions at 1630 cm⁻¹ and 1025 cm⁻¹ may be attributed to C═N and C—N stretches from imine and amine-type structures respectively, suggesting a small extent of reaction on the nitrile moiety.

After the subsequent carbonization procedure (second step), S-PAN composites were produced from the PAN materials. FIG. 2b illustrates the FTIR spectra of the final composites, confirming both cyclization of the main carbon-nitrogen backbone and covalent bond formation between sulfur and carbon. The cyclization was first established with both symmetric and asymmetric C═N stretches at 1240 cm⁻¹ and 1430 cm⁻¹ between carbon and nitrogen, while strong symmetric and asymmetric C═C bands at 1500 cm⁻¹ and 1550 cm⁻¹ indicated sp²-hybridization characteristic of conjugation and therefore electrical conductivity in the composite. Additional bands were also observed at 800 cm⁻¹ corresponding to C═N hexahydric ring breathing and at 1360 cm⁻¹ associated with C—C deformations.

Covalent sulfur bonding was also ascertained with the 670 cm⁻¹ band for C—S stretching between carbon and sulfur atoms in the composite. Bands at 513 cm⁻¹ and 940 cm⁻¹ respectively for S—S stretching and S—S ring breathing modes indicated that the bonded sulfur existed as short chains, typically 2 to 4 atoms in length.

Elemental Analysis of Sulfur-Polyacrylonitrile Composites

Elemental combustion analysis was used to determine exact sulfur compositions in each composite.

With sulfur itself being the active species contributing to the capacity of the sodium-sulfur battery, the exact sulfur content (by weight) of each S-PAN composite was determined using elemental combustion analysis. As tabulated in Table 2, pure S-PAN and S-PAN-CNT have fairly similar sulfur contents at 36% and 39% respectively. S-PAN-KB contained a marginally higher amount of carbon in comparison, and a lower sulfur composition of close to 30%. As a comparison, sulfur contents of pure particulate-type S-PAN composites range typically between 30% and 45%. Contrastingly, S-PAN-Cloth showed the least sulfur at 3.6%, but with significantly more carbon. This is nonetheless expected as the cloth-based composite consists primarily of woven carbon fibers, with the S-PAN existing as a thin layer over individual fibers as observed from SEM in FIG. 1i and FIG. 1l.

TABLE 2
Elemental compositions of carbon-supported and pure S-PAN composites by combustion analysis.

| | Elemental composition wt. % | | | |
|---|---|---|---|---|
| Composite Material | C | H | N | S |
| Pure S-PAN | 41.9 | 0.7 | 15.1 | 36.3 |
| S-PAN-CNT | 42.6 | 0.4 | 13.5 | 39.4 |
| S-PAN-KB | 43.8 | 0.5 | 13.4 | 29.7 |
| S-PAN-Cloth | 60.2 | 1.5 | 14.2 | 3.6 |

### Example 2

The preparation of battery cathodes and full cell assemblies is described here.

Cells were assembled using the carbonized samples obtained from Example 1, and tested in combination with sodium trifluoromethanesulfonate (NaCF₃SO₃) electrolyte in a 1:1 volume mixture of ethylene carbonate and diethyl carbonate.

For battery cathode preparation, the carbonized pure S-PAN and S-PAN composites were ground in an agate mortar with conductive carbon (Super P, obtained from Alfa Aesar, Singapore), and mixed with polymer binder (polyvinylidene fluoride, PVDF, obtained from Sigma-Aldrich, Singapore) in a weight ratio of 7:2:1 with N-methyl-2-pyrrolidone (NMP) solvent to yield a viscous slurry. Slurries were then coated onto carbon-coated aluminium foil (obtained from MTI Corporation, of California of the United States of America) with a doctor blade and allowed to dry completely at 70° C. For S-PAN-Cloth, the carbonized S-PAN-Cloth from Example 1 was used as-is, without further addition of binder or conductive carbon. Areal sulfur loadings for all four cathode materials were rigorously fixed between 0.5-0.6 mg_{(S)}·cm⁻².

Sodium-sulfur cells were fabricated as 2032-type coin cells. Assembly was done in an argon-filled glovebox with the respective S-PAN composites (11.28 mm diameter) used as the cathode. Freshly cut sodium blocks (99.9%) were rolled into sheets and cut into circular discs which served as the anode, separated by a Celgard membrane filled with 1 M sodium trifluoromethanesulfonate (NaCF₃SO₃) electrolyte in a 1:1 volume solvent mixture of ethylene carbonate (EC) and diethyl carbonate (DEC).

Sodium-Sulfur Battery Performance

The stability and performance of porous carbon-supported S-PAN composites after their integration as cathode material in sodium-sulfur batteries were investigated. The high porosity carbon-supported composite (S-PAN-KB) and the macroporous S-PAN-Cloth demonstrated the best cycling stabilities, with highest capacity retention after extended cycling.

Full cell fabrication was performed using each S-PAN composite as cathode in conjunction with a pure sodium anode, and tested using sodium trifluoromethanesulfonate (NaCF₃SO₃) in ethylene carbonate and diethyl carbonate as electrolyte.

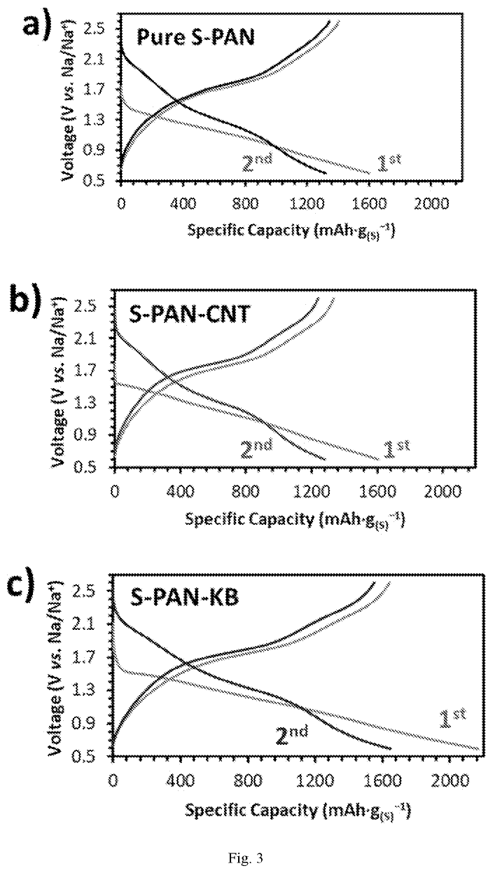

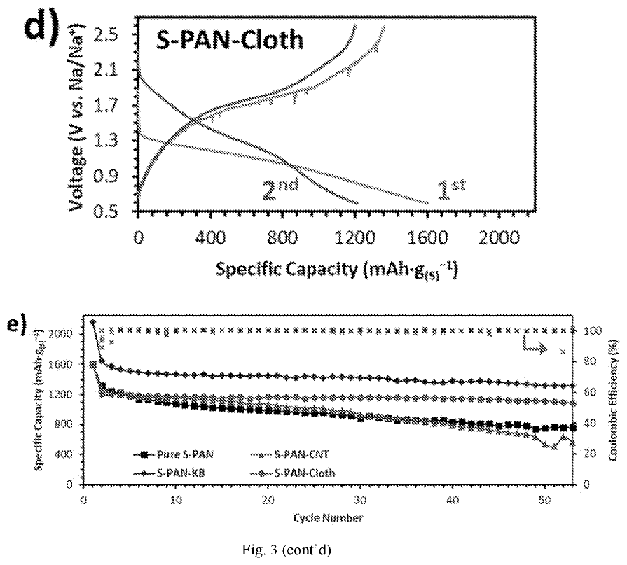

FIG. 3a to FIG. 3d illustrates the galvanostatic charge/discharge profiles of the S-PAN composite cathodes prepared according to the cell assembly method described above where FIG. 3a applies to pure S-PAN cathode, FIG. 3b applies to S-PAN-CNT, FIG. 3c applies to S-PAN-KB and FIG. 3d applies to S-PAN-Cloth. Their performances were tested by charge/discharge cycling at 0.2 C (where 1 C=1673 mA·g(s)⁻¹, as the theoretical specific capacity of sulfur is 1673 mAh·g_{(S)}⁻¹ The first discharge process started from ca. 1.6 V vs. Na/Na⁺ reaching just above 1600 mAh·g_{(S)}⁻¹ for the pure S-PAN, S-PAN-CNT, and S-PAN-Cloth cathodes, therefore indicating that the majority of the loaded sulfur had reacted. S-PAN-KB in contrast, had a higher first discharge capacity of 2150 mAh·g_{(S)}⁻¹, exceeding the theoretical capacity of sulfur. This added capacity arises however from sodiation of the S-PAN carbon-nitrogen backbone, which is itself an irreversible process, occurring simultaneously with the conversion of sulfur to sodium sulfide (Na₂S). Additionally, the high surface area and porosity of the KB carbon scaffold indirectly contributed to the increased capacity by allowing a greater contact surface between the S-PAN active material and the electrolyte. Upon the first charge cycle, Na₂S discharge products were reconverted back to sulfur. Although the initial charge profile of the S-PAN-Cloth experienced minor voltage drops, this eventually stabilized and was not observed in subsequent cycles from the 2^{nd} charge onwards (FIG. 3d).

In all composites, the second discharge was initiated at ca. 2.1 V vs. Na/Na⁺ with capacities of 1200-1300 mAh·g_{(S)}⁻¹ recovered for the pure S-PAN, S-PAN-CNT, and S-PAN-Cloth Again, S-PAN-KB maintained a notably higher capacity ca. 1640 mAh·g_{(S)}⁻¹, contributed by its higher surface area. Average Coulombic efficiencies of all composites also remained high at >99.9% (FIG. 3e) on average over 50 cycles, indicating good chemical stability of the composites and their polysulfide intermediates in the presence of the reactive sodium anode.

Most notable however, is the difference in capacity retention of the porous carbon-supported composites. While the capacities of mesoporous S-PAN-KB and macroporous S-PAN-Cloth rapidly stabilised in the early cycles, the unsupported pure S-PAN and S-PAN-CNT (i.e. low surface area and porosity) counterparts continued on a gradual decline, maintaining only ca. 750 mAh·g_{(S)}⁻¹ and 550 mAh·g_{(S)}⁻¹ at their 50^{th} cycles. Conversely, the mesoporous S-PAN-KB retained a high 1300 mAh·g_{(S)}⁻¹, and the macroporous S-PAN-Cloth with 1110 mAh·g_{(S)}⁻¹ (i.e. 80% and 91% capacity retention respectively).

These results correlate with the extent to which the carbon supports are able to provide for volume expansion, which can arise either from their (1) high surface area and pore volume, in the case of S-PAN-KB; or (2) unique morphologies such as S-PAN-Cloth, where the composite layer on each fiber has adequate space for radial expansion.

In S-PAN-KB, the high surface area of the mesoporous KB scaffold permits a greater contact surface between the active sulfur and the electrolyte, thus achieving a higher capacity than other substrates. Furthermore, its high total pore volume contributes to its high capacity retention with cycling.

Conversely for S-PAN-Cloth, its low surface area results in a lower initial capacity similar to the unsupported composite. Nonetheless, its unique morphology as a thin layer covering each fiber permits radial expansion during discharge cycles, thus avoiding structural degradation and maintaining the highest capacity retention of all materials.

Hence, the use of porous additives and structures as described herein to address cathode stability is an important strategy in the development of sodium-sulfur batteries.

### INDUSTRIAL APPLICABILITY

The disclosed composite may be used as a cathode, which in turn can be used in an electrochemical cell. Therefore, the present application finds utility in electrochemistry and energy-related industries.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A composite comprising: a) short chain sulfur; and b) a carbon-supported conductive polymer, wherein sulfur atoms of said short chain sulfur are covalently linked to the conductive polymer of said carbon-supported conductive polymer via a C—S bond.

2. The composite according to claim 1, wherein said composite is a two-component composite.

3. The composite according to claim 1, wherein said conductive polymer is a carbonized polymer.

4. The composite according to claim 1, wherein said conductive polymer comprises a plurality of monomers and said carbon-supported conductive polymer comprises a polymerized form of said plurality of monomers on or within a carbon support.

5. The composite according to claim 4, wherein said conductive polymer is selected from the group consisting of carbonized polyacrylonitrile (PAN), polyaniline, polypyrrole, polyacetylene, polyphenylene, polyphenylene sulfide, polythiophene, poly(fluorene)s, polypyrenes, polyazulenes, polynaphthalenes, polycarbazoles, polyindoles, polyazepines, poly(3,4-ethylenedioxythiophene) (PEDOT), poly(p-phenylene sulfide) (PPS), poly(p-phenylene vinylene) (PPV), and co-polymers mixtures thereof.

6. The composite according to claim 5, wherein the monomers of said conductive polymer is selected from the group consisting of acrylonitrile, aniline, pyrrole, acetylene, phenylene, phenylene sulfide, thiophene, (fluorene)s, pyrenes, azulenes, naphthalenes, carbazoles, indoles, azepines, 3,4-ethylenedioxythiophene, p-phenylene sulfide, p-phenylene vinylene, and mixtures thereof.

7. The composite according to claim 4, wherein said carbon support comprises a particulate porous carbon or a fibrous carbon.

8. The composite according to claim 7, wherein said particulate porous carbon has a surface area in the range of 100 m²/g to 2000 m²/g and an average pore size or average pore distribution size in the range of 2 nm to 500 nm.

9. The composite according to claim 7, wherein said fibrous carbon is a carbon cloth comprising fibers having a diameter in the range of 3 μm to 20 μm and having a cloth thickness in the range of 200 μm to 500 μm.

10. The composite according to claim 1, wherein said short-chain sulfur is selected from S₂, S₃, S₄ or mixtures thereof.

11. The composite according to claim 1, wherein said short-chain sulfur is present in said composite in a concentration in the range of 20 wt % to 50 wt %, based on the total weight of said composite.

12. The composite according to claim 1, wherein said short-chain sulfur and said conductive polymer is present in said composite at a ratio in the range of 2:1 to 6:1.

13. A method of preparing a composite comprising: a) short-chain sulfur; and
b) a carbon-supported conductive polymer, wherein sulfur atoms of the short-chain sulfur are covalently linked to the conductive polymer of the carbon-supported conductive polymer via a C—S bond, comprising the steps of:
(a) polymerizing, in the presence of a carbon scaffold, a plurality of monomers making up the conductive polymer or a plurality of monomers making up a precursor of the conductive polymer;
(b) mixing elemental sulfur with said carbon-supported conductive polymer or the carbon-supported conductive polymer precursor obtained in step (a); and
(c) heating the mixture of the elemental sulfur with the carbon-supported conductive polymer precursor obtained in step (b).

14. The method according to claim 13, further comprising, before step (a), the steps of:
(a1′) adding a polymerization initiator to a mixture of said plurality of monomers and said carbon scaffold in a solvent; or
(a1″) adding said plurality of monomers to a mixture of a polymerization initiator and said carbon scaffold in a solvent; and
(a2) heating said mixture from step (a1′) or step (a1″) to initiate polymerization.

15. The method according to claim 13, wherein said heating step (c) is undertaken at a temperature in the range of 400° C. to 600° C.

16. A cathode material comprising a composite comprising: a) short chain sulfur; and b) a carbon-supported conductive polymer, wherein sulfur atoms of said short chain sulfur are covalently linked to the conductive polymer of said carbon-supported conductive polymer via a C—S bond.

17. A sodium-sulfur electrochemical cell comprising a cathode material comprising a composite comprising: a) short chain sulfur; and b) a carbon-supported conductive polymer, wherein sulfur atoms of said short chain sulfur are covalently linked to the conductive polymer of said carbon-supported conductive polymer via a C—S bond.

18. An electrochemical cell comprising a pure sodium anode, a liquid electrolyte, and a cathode material comprising a composite comprising: a) short chain sulfur; and b) a carbon-supported conductive polymer, wherein sulfur atoms of said short chain sulfur are covalently linked to the conductive polymer of said carbon-supported conductive polymer via a C—S bond.

19. The electrochemical cell according to claim 18, wherein said liquid electrolyte comprises sodium trifluoromethanesulfonate dissolved in a mixture of solvents.
